(19) United States
(12) Patent Application Publication
(10) Pub. No.: US 2023/0044296 A1
(43) Pub. Date: Feb. 9, 2023

(54) METHOD AND APPARATUS FOR PROVIDING USER WITH LEARNING JOURNEY

(71) Applicant: RIIID INC., Seoul (KR)

(72) Inventors: Su Hong CHU, Seongnam-si (KR); Min Sung Noh, Seoul (KR); Hae Chan Kim, Seoul (KR); Bo Ra Kim, Hwaseong-si (KR)

(73) Assignee: RIIID INC., Seoul (KR)

(21) Appl. No.: 17/848,857

(22) Filed: Jun. 24, 2022

(30) Foreign Application Priority Data
Jun. 25, 2021 (KR) 10-2021-0083406
Mar. 14, 2022 (KR) 10-2022-0032147

(51) Int. Cl. G09B 5/02; G06F 3/04817; G09B 7/02

(52) U.S. Cl. CPC G09B 5/02; G06F 3/04817; G09B 7/02

(57) ABSTRACT

A method of providing learning to a user by a terminal includes the steps of: receiving user information from the user; displaying a first area for delivering information provided by a server to the user on the basis of the user information; displaying a second area for delivering a learning journey of the user to the user, wherein the second area includes a first icon representing a score predicted through a first test, one or more second icons representing a score predicted for each learning cycle, and a third icon representing a target score of the user; displaying an icon representing a learning cycle being performed by the user in the second area; and displaying a third area for delivering information related to the learning cycle being performed by the user.

### BACKGROUND OF THE INVENTION

### Field of the Invention

The present specification relates to a method for providing a learning journey for improving scores of a user by a terminal through deep learning, and an apparatus for the method.

### Description of the Related Art

The most important problem for users of educational services is to find a way to effectively improve skills of user's insufficient parts (e.g., writing, reading, or listening).

To this end, the user should know how much the user lacks, and needs to select how to study in order to improve the skills of user's insufficient parts.

However, in the existing academia or industry, there has not been much effort to alleviate such burden of users by using artificial intelligence (AI).

### SUMMARY OF THE INVENTION

An object of the present specification is to provide a user interface which recommends an appropriate learning journey in accordance with user's skills through an artificial intelligence model.

In addition, an object of the present specification is to provide a user interface through which users can more efficiently determine their skills, select appropriate learning, and study, in order to improve user's skills.

The technical problems to be achieved by the present specification are not limited to the technical problems mentioned above, and other technical problems not mentioned may be clear to those of ordinary skill in the art to which the present specification belongs from the detailed description of the following specification.

According to an aspect of the present specification, there is provided a method of providing learning to a user by a terminal, including: a step of receiving user information from the user; a step of displaying a first area for delivering marketing information provided by a server to the user on the basis of the user information; a step of displaying a second area for delivering a learning journey of the user to the user, wherein the second area includes a first icon representing a score predicted through a first test, one or more second icons representing a score predicted for each learning cycle, and a third icon representing a target score of the user; a step of displaying an icon representing a learning cycle being performed by the user in the second area; and a step of displaying a third area for delivering information related to the learning cycle being performed by the user.

In addition, the method may include a step of receiving a tap for the one or more second icons from the user; a step of changing and displaying a color of the second icon corresponding to the tap; and a step of displaying information corresponding to the color-changed second icon in the third area.

In addition, the step of displaying the third area may include a step of displaying a first frame for presenting information of the learning cycle being performed by the user; a step of displaying a second frame for presenting information related to learning of the learning cycle being performed by the user; and a step of displaying a third frame for presenting a learning card related to the learning.

In addition, the second frame may include one or more blocks, the block may be displayed on the basis of policy set in the terminal, the policy may include 1) a creation time, 2) a status, and 3) a type of the block, and the type may include information about learning recommended by the server.

In addition, the third frame may include one or more learning cells, the learning cell may include 1) a type, 2) a title, 3) a tag, and 4) an icon of the learning cell, and the type may include a lecture, a vocabulary, and a question.

In addition, the third frame may include a completion area for presenting completed learning cells, and the completed learning cells are sorted in the order of the most recently completed learning cells and presented in the completion area.

In addition, the method may further include: a step of delivering 1) a predicted score of a current cycle of the user and 2) information about whether the user has experience of the present test to the server; a step of receiving 1) a type and 2) content information of the selected learning cell on the basis of 1) the predicted score of the current cycle of the user and 2) the information about whether the user has experience of the present test from the server; and a step of displaying the selected learning cell in the third frame on the basis of 1) the type and 2) the content information of the selected learning cell.

In addition, the type of the selected learning cell may be selected on the basis of a probability value preset in the server.

In addition, the contents of the selected learning cell may be selected through a knowledge tracing (KT) model of the server.

According to another aspect of the present specification, there is provided a terminal which provides learning to a user, including: a communication module; a memory; a display unit; and a processor. The processor may receive user information from the user through the communication module, display a first area for delivering marketing information provided by a server to the user on the display unit on the basis of the user information, and display a second area for delivering a learning journey of the user to the user. The second area may include a first icon representing a score predicted through a first test, one or more second icons representing a score predicted for each learning cycle, and a third icon representing a target score of the user. The processor may display an icon representing a learning cycle being performed by the user in the second area, and display a third area for delivering information related to the learning cycle being performed by the user.

### BRIEF DESCRIPTION OF THE DRAWINGS

FIG. 1 is a block diagram illustrating an electronic apparatus related to the present specification;

FIG. 2 is a block diagram illustrating an AI device according to an embodiment of the present specification;

FIG. 3 is a diagram illustrating an example of a terminal screen according to the present specification;

FIG. 4 is a diagram illustrating an example of a Journey area according to the present specification;

FIG. 5 is a diagram illustrating an example of displaying an icon of a Journey area according to the present specification;

FIG. 6 is a diagram illustrating an example of a lower background area according to the present specification;

FIG. 7 is a diagram illustrating an example of an AI message block according to the present specification;

FIG. 8 is a diagram illustrating a learning cell according to the present specification;

FIG. 9 is a diagram illustrating an example of a learning cell delivery method of a server according to the present specification; and

FIG. 10 is a diagram illustrating an embodiment of a terminal according to the present specification.

The accompanying drawings, which are included as a part of the detailed description to help the understanding of the present specification, provide embodiments of the present specification, and together with the detailed description, explain the technical features of the present specification.

### DETAILED DESCRIPTION OF THE PREFERRED EMBODIMENTS

Hereinafter, the embodiments disclosed in the present specification will be described in detail with reference to the accompanying drawings, but the same or similar components are assigned the same reference numbers regardless of reference numerals, and redundant description thereof will be omitted. The suffixes “module” and “unit” for the components used in the following description are given or mixed in consideration of only the ease of writing the specification, and do not have distinct meanings or roles by themselves. In addition, in describing the embodiments disclosed in the present specification, if it is determined that detailed descriptions of related known technologies may obscure the gist of the embodiments disclosed in the present specification, the detailed description thereof will be omitted. In addition, the accompanying drawings are only for easy understanding of the embodiments disclosed in the present specification, and the technical idea disclosed in the present specification is not limited by the accompanying drawings, and should be understood to include all changes, equivalents, or substitutes included in the spirit and scope of the present specification.

Terms including an ordinal number, such as first, second, etc., may be used to describe various components, but the components are not limited by the terms. The above terms are used only for the purpose of distinguishing one component from another.

When a certain component is referred to as being “connected” or “linked” to another component, it may be directly connected or linked to the other component, but it should be understood that other components may exist in between. On the other hand, when it is mentioned that a certain component is “directly connected” or “directly linked” to another component, it should be understood that no other component exists in between.

The singular expression includes the plural expression unless the context clearly dictates otherwise.

In the present application, terms such as “include” or “have” are intended to designate that the features, numbers, steps, operations, components, parts, or combinations thereof described in the specification exist, and it should be understood that the possibility of presence or addition of one or more other features, numbers, steps, operations, components, parts, or combinations thereof is not excluded.

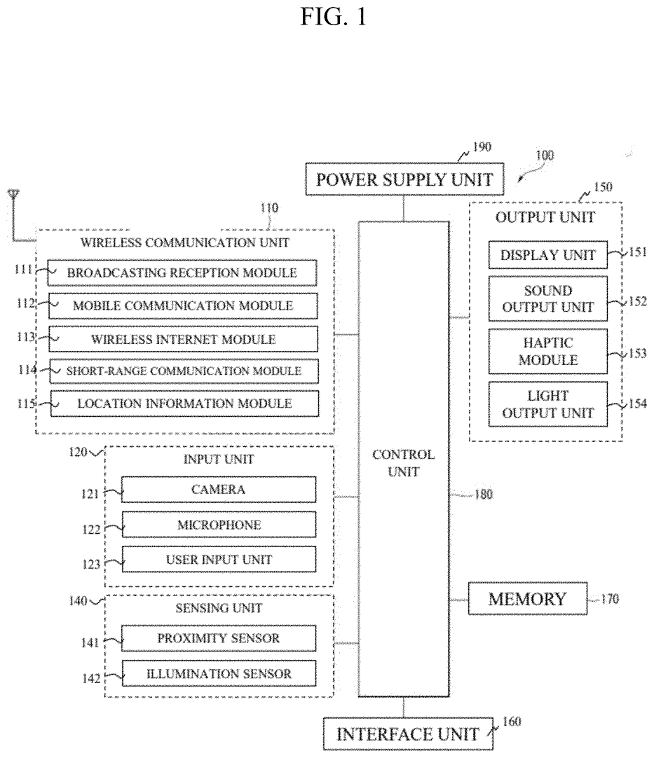

FIG. 1 is a block diagram illustrating an electronic apparatus according to the present specification.

The electronic apparatus 100 may include a wireless communication unit 110, an input unit 120, a sensing unit 140, an output unit 150, an interface unit 160, a memory 170, a control unit 180, a power supply unit 190, and the like. The components illustrated in FIG. 1 are not essential in implementing the electronic apparatus, and the electronic apparatus described in the present specification may have more or fewer components than the components listed above.

More specifically, the wireless communication unit 110 of the components may include one or more modules which enable wireless communication between the electronic apparatus 100 and a wireless communication system, between the electronic apparatus 100 and another electronic apparatus 100, or between the electronic apparatus 100 and an external server. In addition, the wireless communication unit 110 may include one or more modules which connect the electronic apparatus 100 to one or more networks.

Such a wireless communication unit 110 may include at least one of a broadcasting reception module 111, a mobile communication module 112, a wireless internet module 113, a short-range communication module 114, and a location information module 115.

The input unit 120 may include a camera 121 or an image input unit for inputting an image signal, a microphone 122 or an audio input unit for inputting an audio signal, and a user input unit 123 (e.g., touch key, push key (mechanical key), etc.) for receiving information from a user. Voice data or image data collected by the input unit 120 may be analyzed and processed by a control command of a user.

The sensing unit 140 may include one or more sensors for sensing at least one of information in the electronic apparatus, surrounding environment information around the electronic apparatus, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensor (e.g., camera 121), a microphone 122, a battery gauge, an environment sensor (e.g., barometer, hygrometer, thermometer, radiation detection sensor, heat detection sensor, and gas detection sensor), and a chemical sensor (e.g., electronic nose, healthcare sensor, and biometric sensor). Meanwhile, the electronic apparatus disclosed in the present specification may utilize combination of information sensed by at least two sensors of such sensors.

The output unit 150 is to generate an output related to sight, hearing, touch, or the like, and may include at least one of a display unit 151, a sound output unit 152, a haptic module 153, and a light output unit 154. The display unit 151 has an inter-layer structure with a touch sensor or is formed integrally, thereby implementing a touch screen. Such a touch screen may serve as a user input unit 123 providing an input interface between the electronic apparatus 100 and a user, and may provide an output interface between the electronic apparatus 100 and the user.

The interface unit 160 serves as a passage with various kinds of external apparatus connected to the electronic apparatus 100. Such an interface unit 160 may include at least one of a wired/wireless headset port, an external charger port, a wired/wireless data port, a memory card port, a port connecting a device provided with an identification module, an audio I/O (Input/Output) port, a video I/O (Input/Output) port, and an earphone port. The electronic apparatus 100 may perform a proper control related to a connected external apparatus in response to connecting an external apparatus to the interface unit 160.

In addition, the memory 170 stores data supporting various functions of the electronic apparatus 100. The memory 170 may store a number of programs (application program or application) running in the electronic apparatus 100, data for operation of the electronic apparatus 100, and commands. At least a part of such application programs may be downloaded from an external server through wireless communication. In addition, at least a part of such application programs may exist on the electronic apparatus 100 from the time of shipment for basic functions (e.g., call receiving and sending functions, and message receiving and sending functions) of the electronic apparatus 100. Meanwhile, the application programs may be stored in the memory 170, installed on the electronic apparatus 100, and driven to perform operations (or functions) of the electronic apparatus by the control unit 180.

In addition to the operations related to the application programs, the control unit 180 generally controls overall operations of the electronic apparatus 100. The control unit 180 may provide or process appropriate information or functions to a user by processing signals, data, information, and the like input or output through the components described above or running the application programs stored in the memory 170.

In addition, the control unit 180 may control at least a part of the components described with reference to FIG. 1 to run the application programs stored in the memory 170. Furthermore, in order to run the application programs, the control unit 180 may operate at least two components included in the electronic apparatus 100 in combination with each other.

The power supply unit 190 receives external power and internal power, and supplies power to each component included in the electronic apparatus 100 under the control of the control unit 180. Such a power supply unit 190 may include a battery, and the battery may be a built-in battery or a replaceable battery.

At least a part of the components may be operated cooperatively with each other to implement an operation, control, or control method of the electronic apparatus according to various embodiments described hereinafter. In addition, the operation, control, or control method of the electronic apparatus may be implemented on the electronic apparatus by running at least one application program stored in the memory 170.

In the present specification, the electronic apparatus 100 may be collectively referred to as a terminal.

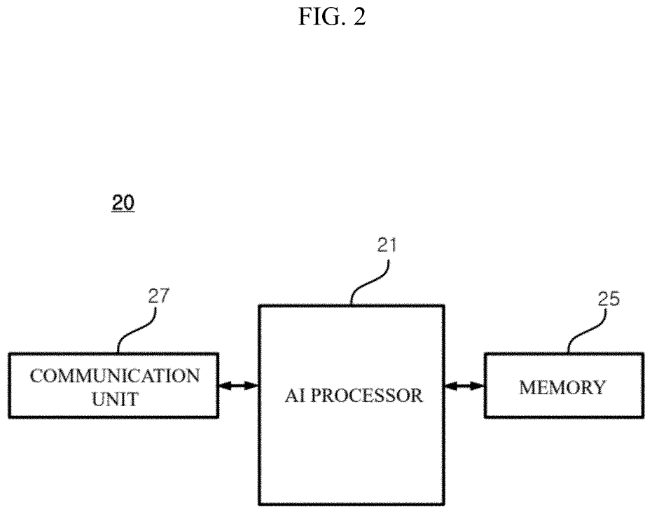

FIG. 2 is a block diagram illustrating an AI device according to an embodiment of the present specification.

The AI device 20 may include an electronic apparatus including an AI module capable of AI processing or a server including the AI module. In addition, the AI device 20 may be included as at least a part of the composition of the electronic apparatus 100 illustrated in FIG. 1, and perform at least a part of the AI processing together.

The AI device 20 may include an AI processor 21, a memory 25, and/or a communication unit 27.

The AI device 20 may be implemented by various electronic device such as a server, a desktop PC, a laptop PC, and a tablet PC, as a computing device capable of learning a neural network.

The AI processor 21 may learn an AI model by using a program stored in the memory 25. Particularly, the AI processor 21 may learn the AI model to predict a user's score and recommend suitable learning to the user on the basis of the predicted score.

Such an AI model may include a knowledge tracing (KT) model. The KT model is a model which performs a task of predicting right and wrong answers about an unseen question by utilizing the past education record of a specific student by using AI. For example, the KT model guesses a learning level of a user by learning questions 1 to 5 solved by the existing user, and may predict right and wrong answers of questions 6 to 8 by utilizing the learning level.

Furthermore, the AI model may include an assessment model. The assessment model is an AI model which performs a task of assessing an actual test score by using a learning log of a user. The actual test scores given through separate tests from accredited institutions such as Scholastic Ability Test, SAT, ACT, TOEIC, Real Estate Agent test, and the like are not easy to collect data. The reason is because, although a mass of learning logs of users may be collected in real time through an education service provided through an electronic apparatus illustrated in FIG. 1, the actual test score data are collected by separate inputs from the users. Accordingly, the AI device according to an embodiment of the present invention may create an assessment model separately from the KT model to assess the actual test score by using the learning log of the user.

Meanwhile, the AI processor 21 performing the functions described above may be a general purpose processor (e.g., CPU), but may be an AI dedicated processor (e.g., GPU) for artificial intelligence learning.

The memory 25 may store various kinds of programs and data necessary for operation of the AI device 20. The memory 25 may be implemented by a non-volatile memory, a volatile memory, a flash memory, a hard disk drive (HDD), a solid state drive (SSD), and the like. The memory 25 may be accessed by the AI processor 21, and the AI processor 21 may perform reading, recording, modifying, deleting, updating, and the like of data. In addition, the memory 25 may store a neural network model (e.g., deep learning model) generated through a learning algorithm for data classification/recognition according to an embodiment of the present specification.

Meanwhile, the AI processor 21 may include a data learning unit which learns a neural network for data classification/recognition. For example, the data learning unit may acquire training data to be used for learning, and apply the acquired training data to a deep learning model, thereby training the deep learning model.

The communication unit 27 may transmit an AI processing result of the AI processor 21 to an external electronic apparatus.

Herein, the external electronic apparatus may include another terminal and server.

Meanwhile, the AI device 20 illustrated in FIG. 2 has been functionally divided into the AI processor 21, the memory 25, the communication unit 27, and the like, but the components described above may be integrated into one module and may be referred to as an AI module.

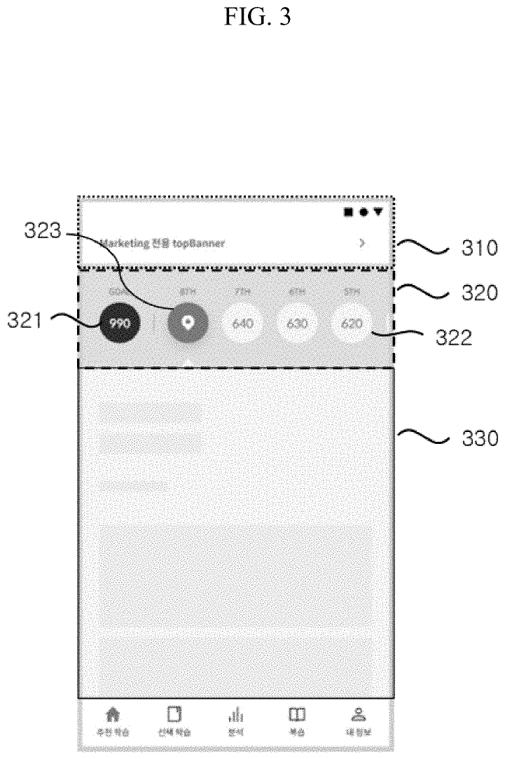

FIG. 3 is a diagram illustrating an example of a terminal screen according to the present specification.

A server may receive right and wrong answer data of practice questions solved by a user and predict a score about a test taken by the user. In addition, in order for the user to obtain a target score in the original test, the server may predict an insufficient part and recommend learning (e.g., word review, listening practice, and grammar lecture) necessary for the user.

For example, a server may collect data from an intelligent tutoring system (ITS) provided in real time to 10,000 or more English L2 learners preparing TOEIC. More specifically, a user of a web and/or mobile app provided by the intelligent tutoring system may study TOEIC reading and/or listening questions. Through the KT, the AI model included in the server may receive data about question solving of the user, and predict a score of the present test and an insufficient degree for each part of the test of the user.

A terminal may communicate with a server through a provided application program and recommend learning necessary for the user.

Referring to FIG. 3, the terminal may display a home screen to the user. The home screen may be mainly divided into three areas, more specifically, the three areas may include a TopBanner 310 for marketing, a Journey area 320 for displaying a learning journey of a user, and a lower background area 330 for displaying information about a current learning cycle. For example, the Journey area 320 may include an icon 321 representing a target score, an icon 322 representing a score predicted for each learning cycle, and an icon 323 representing a current learning cycle.

For example, the terminal may display a learning cycle representing a score predicted through a first test as a first learning cycle and a learning cycle representing a target score in the Journey area 320. Thereafter, when the user performs learning through a new learning cycle, an icon representing the current learning cycle may be displayed in the Journey area 320. When the learning cycle is completed, a score for the learning cycle may be displayed in an icon representing the current learning cycle. Then, when the user performs the next learning cycle, an icon representing the new current learning cycle may be displayed in the Journey area 320.

For example, the learning cycle may be formed in a direction capable of raising a user skill at the corresponding time point. For example, the user skill may be a predicted score calculated in the AI model, and the learning cycle may be formed with contents capable of raising the predicted score of the user at a specific time point among contents included in a tutoring system. For example, one cycle may be configured mainly based on basic vocabulary contents and basic lecture contents for a user with a low predicted score, but one cycle may be configured mainly based on practical question contents for a user with a high predicted score.

For example, in FIG. 3, when a score of a user predicted at the first time point is 500 points and a target score of the user is 990 points, a terminal may display an arbitrary number of learning cycles necessary for the user to achieve the target score at the first time point in the Journey area 320.

Thereafter, when the user performs each learning cycle at the second time point, the AI model may calculate a predicted score of the user at the second time point, and the terminal may display the calculated predicted score in the icon of the learning cycle in the Journey area 320. Furthermore, the AI model may recalculate a learning cycle necessary for the user to achieve the target score at the second time point, and the terminal may display an arbitrary number of learning cycles in the Journey area 320.

According to such an embodiment, although users have similar skills and target scores at an arbitrary time point, the predicted score and the number of learning cycles for achieving the target score of each user may vary according to the journey of performing the learning cycles provided by the terminal. Since such a learning journey is displayed in the Journey area 320 of the terminal, the user may know the past, present, and future learning processes of the user, and learning motivation may be increased.

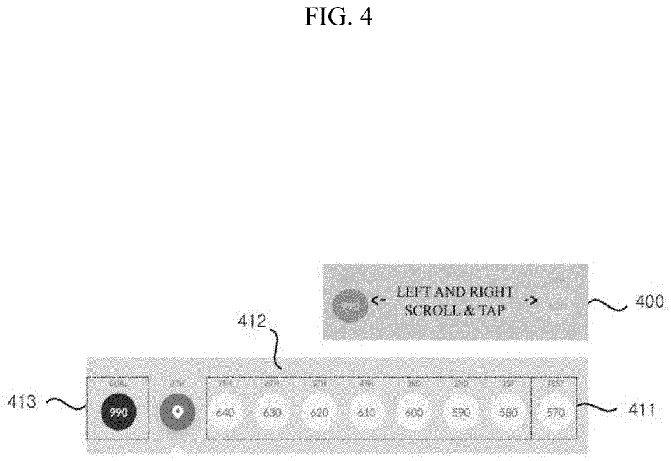

FIG. 4 is a diagram illustrating an example of a Journey area according to the present specification.

Referring to FIG. 4, a terminal may receive left/right scrolling and/or tap motion of a user in a Journey area 400 through a display unit. The user may check a score 411 predicted through the first test, a score 412 predicted for each learning cycle, and a target score 413 through left/right scrolling in the Journey area 400. Through this, the user may easily check history information about the learning journey of the user. In addition, the terminal may display information corresponding to each cycle in the lower background area 330 in response to the icon tapped by the user.

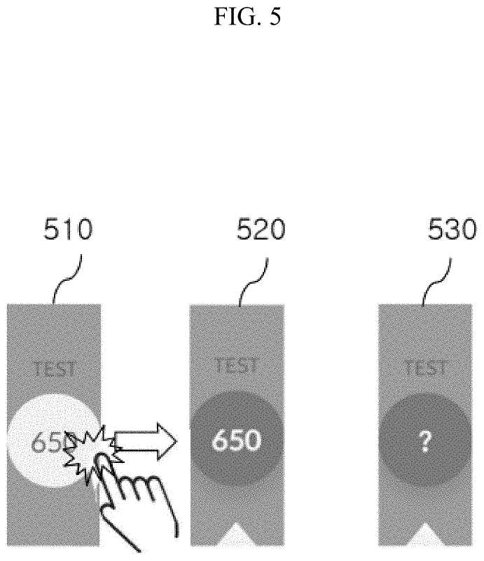

FIG. 5 is a diagram illustrating an example of displaying an icon of the Journey area according to the present specification.

Referring to FIG. 5, a terminal may change a shape of an icon in accordance with a learning cycle status indicated by the icon tapped by a user. For example, when a user taps an icon 510 to perform a specific learning cycle, the inside of the icon may be filled with a specific color to display that the user tapped the icon 520. The terminal may display contents which may be presented in the cycle in the lower background area 330 in response to the icon tapped by the user. If there is no predicted score information of the learning cycle indicated by the tapped icon, “?” may be displayed on the tapped icon 530.

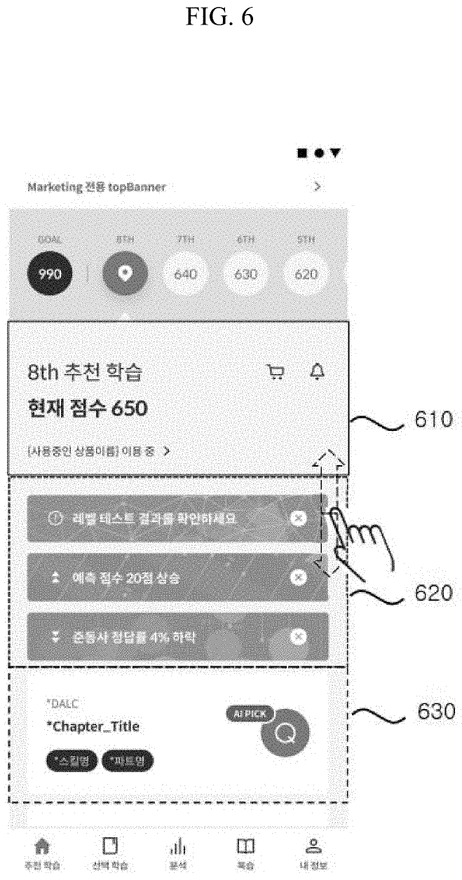

FIG. 6 is a diagram illustrating an example of a lower background area according to the present specification.

The lower background area may include a notification page 610, an AI message block 620, and a learning cell 630.

The notification page 610 includes information of a current cycle, a predicted score of the current cycle, and information about a product being used through the application program by a user.

The AI message block 620 may be displayed in association with a cycle and contents of a learning cell. In addition, the AI message 620 may include learning information recommendable through the AI model of the server.

The following Table 1 and Table 2 illustrate creation time, type, and description of the AI message blocks according to the present specification.

TABLE 1

| Creation time | Type | Description |
|---|---|---|
| Cell completion | Information | Why does skills different from the |
| time | | learning content change? |
| Cycle creation | Information | Why is the score different from Santa |
| time | | TOEIC? |
| Cell completion | AI PICK | Add lessons you need the most right |
| time | | now. |
| Cell completion | Increase | Predicted score increased by {score}. |
| time | | |
| Cell completion | Increase | {skill_value_name} correct answer rate |
| time | | increased by {KT}% |
| Cell completion | Increase | {chapter_value_name} correct answer |
| time | | rate increased by {KT}%. |
| Cell completion | Information | If you learn too fast, your accuracy |
| time | | will decrease. |
| Cell completion | Information | Why do scores change so much? |
| time | | |
| Cycle creation | Information | Check your skills in 3 minutes |
| time | | |
| Cycle creation | Information | If you solve 5 recommended learnings, |
| time | | the score accuracy is 95%. |
| Cycle creation | Information | How do you predict your score? |
| time | | |
| Cycle creation | Information | How do you predict the correct answer |
| time | | rate? |
| Cycle creation | Information | If you solve 2 more, the score accuracy |
| time | | is 95% |
| Cycle creation | Information | Congratulations! You achieve 95% score |
| time | | accuracy. |
| Cycle creation | Information | {n} Recommended learning has arrived. |
| time | | |
| Cell completion | Decrease | Predicted score decreased by {score}. |
| time | | |
| Cell completion | Decrease | {skill_value_name} correct answer rate |
| time | | decreased by {KT}%. |
| Cell completion | Decrease | {chapter_valye_name} correct answer |
| time | | rate decreased by {KT}%. |

TABLE 2

| Creation time | Type | Description |
|---|---|---|
| Cell completion | Information | Totallearningtime {HH:MM:SS} |
| time | | achieved! |
| Cell completion | Information | Please update your target test date. |
| time | | |
| Cell completion | Information | How was your TOEIC test result? |
| time | | |
| Cell completion | Information | One day left for TOEIC test! Cheer up. |
| time | | |
| Cycle creation | Information | Why do I need a level test? |
| time | | |
| Cycle creation | Information | The next recommended learning is a |
| time | | mock test! |
| Cycle creation | Information | What is a mock test? |
| time | | |
| Cycle creation | Information | What is a recommended learning? |
| time | | |
| Cycle creation | Information | When will you take the TOEIC test? |
| time | | |
| Cycle creation | Information | Please enter your actual TOEIC score. |
| time | | |
| Cell completion | Information | Why did my correct answer rate go up |
| time | | but my score dropped? |
| Cell completion | Information | Why does the correct answer rate |
| time | | change so much? |
| Cell completion | Information | Why do skills that have nothing to do |
| time | | with learning change? |
| Cycle creation | Information | Check the level test result. |
| time | | |

The learning cell 630 may include a learning card of a learning cell provided on the home screen.

A user may check information displayed in the lower background area through scrolling and flicking on the display unit of the terminal. In addition, when the user taps the notification page 610, the AI message block 620, or the learning cell 630, the terminal may display detailed information of contents corresponding to the part tapped by the user.

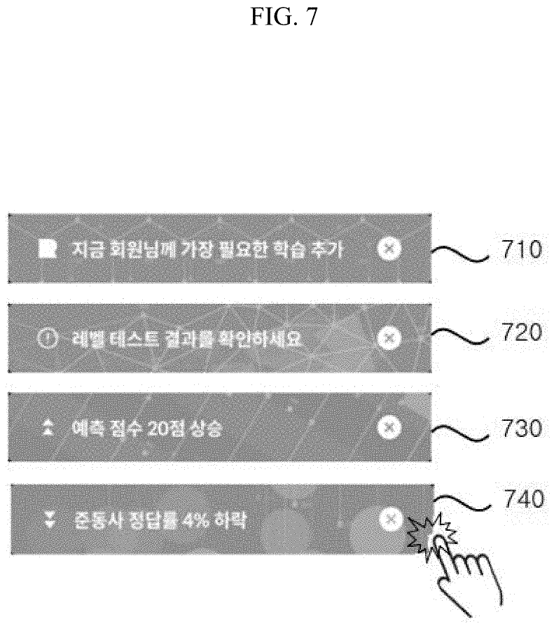

FIG. 7 is a diagram illustrating an example of an AI message block according to the present specification.

Referring to FIG. 7, policy of the AI message block 620 set in the terminal may be as follows.

1. Block creation time

1) Recommended learning (cycle) creation time

2) Learning cell completion time which is not the last

2. Block status

1) Created

2) Consumed

3) Expired

3. Block type

1) AI pick 710

2) Information 720

3) Increase 730

4) Decrease 740

4. Consumption policy

1) When a user taps an AI message block to move to a detail page (when there is a detail page)

2) When a user taps an AI message block to close a block (when there is no detail page)

5. Expiration policy

1) An AI message block remaining at the time point when a new AI message block is generated is processed as expiration

6. Target data
predicted score acquirable through question solving data of a user in an AI model of a server, KT values of all skills and/or KT values of all chapters
   7. Data comparison policy
current: cycle creation or cell completion time
previous: previous block creation time

Again, referring to FIG. 7, the terminal may create an AI message block at the time of creating a cycle. For example, the terminal may display the AI message block in accordance with a learning cell of the cycle.

More specifically, when the learning cell is completed and the following conditions are satisfied, the terminal may display a corresponding type of AI message block.

(1) Adaptive generation, one ‘AI pick’

For example, when a chapter tag correct answer rate of the current learning cell is higher (5%) than before learning the learning cell at the time of completing learning of the learning cell, the server may predict that learning other than the current learning is more effective since the learning effect is higher than expected, and may recommend changing the current learning. When the user taps the AI message block (AI pick) including such information, the terminal may change the existing learning cell to a server-recommended learning cell.

If the chapter tag correct answer rate of the current learning cell is lower than before learning the learning cell, the server may predict that the user should study more since the learning effect is lower than expected, and may recommend adding a learning cell instead. When the user taps the AI message block (AI pick) including such information, the terminal may add a learning cell recommended by the server.

If the increase rate is 0% to 5%, the server may not recommend learning.

(2) When a user completes a learning cell within 2 minutes, one ‘information’

(3) When a predicted score is dramatically changed, one ‘information’

(4) When a predicted score is increased, one ‘information’

(5) When a skill correct answer rate is increased, one ‘information’ (e.g., only one skill with the greatest increase is output)

(6) When a chapter correct answer rate is increased, one ‘information’ (e.g., only one chapter with the greatest increase is output)

(7) A predicted score is decreased, one ‘information’

(8) A skill correct answer rate is decreased, one ‘information’ (e.g., only one skill with the greatest decrease is output)

(9) A chapter correct rate is decreased, one ‘information’ (e.g., only one chapter with the greatest decrease is output)

In addition, the AI message block 620 may have the following priority, and the terminal may sort and display the AI message block 620 in accordance with the priority.

### 1. Priority

AI pick 701>Information 720>Increase 730>Decrease 740
   2. Priority in the same type
‘Increase’ Score increase>Skill increase>Chapter increase
Only one skill with the greatest increase is output.
Only one chapter with the greatest increase is output.
‘Decrease’ Score decrease>Skill decrease>Chapter decrease
Only one skill with the greatest decrease is output.
Only one chapter with the greatest decrease is output.

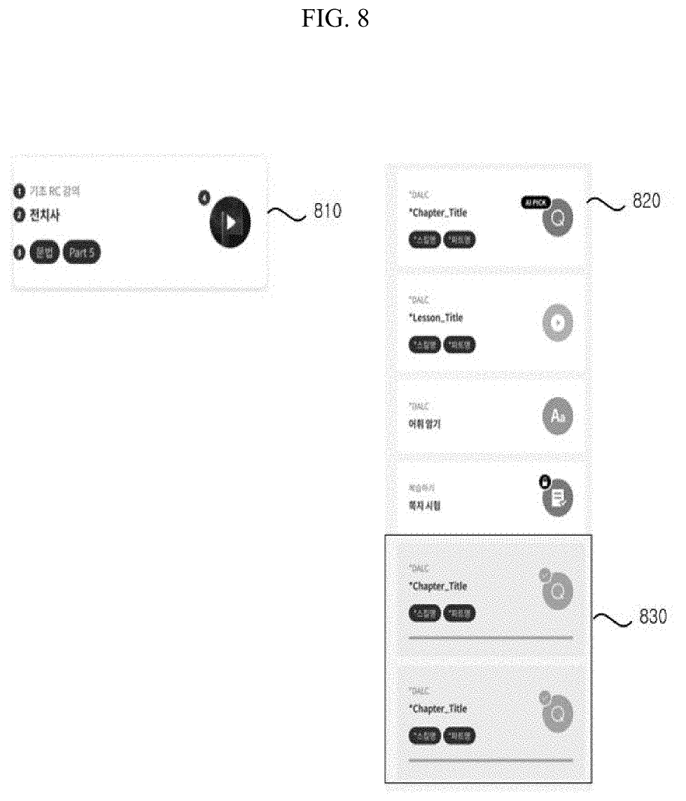

FIG. 8 is a diagram illustrating an example of a learning cell according to the present specification.

Referring to FIG. 8, a terminal may display a learning cell corresponding to a cycle.

For example, a learning cell 810 may include the following information.

1. Type/2. Title/3. Tag/4. Icon

The following Table 3 is an example of a configuration of each type of a learning cell according to the present specification.

TABLE 3

| Cell Type | 1. Type | 2. Title | 3 . Tag | 4. Icon |
|---|---|---|---|---|
| Lecture | [symbol] | [symbol] | [symbol] | Lecture |
| | | | | icon |
| Vocabulary | [symbol] | [symbol] | None | Vocabulary |
| | | | | icon |
| Question | [symbol] | [symbol] | [symbol] | Question |
| | | | | icon |
| AI cycle | [symbol] | [symbol] | None | Test icon |
| review | | | | |
| Level test | [symbol] | [symbol] | None | Test icon |
| Practical | [symbol] | [symbol] | None | Test icon |
| mock test | | | | |
| Adaptive | Lecture/ | Lecture/ | Lecture/ | Add AI |
| | Vocabulary/ | Vocabulary/ | Vocabulary/ | pick |
| | Question | Question | Question | display |
| | According to | According to | According to | |
| | cell_type | cell_type | cell_type | |
| | definition | definition | definition | |

When the learning is completed, the learning cell may be changed to a completion status. When the user taps the learning cell, a learning result page of the learning cell may be displayed.

The terminal may display the order of learning cells delivered by the server as it is. When the user completes learning corresponding to learning cells, the completed learning cells may be sorted and displayed in a completion area 830 at the lower end. For example, the terminal may display the completed learning cells of the completion area 830 in order, with the most recently learning-completed learning cell being the topmost.

The ‘AI pick’ learning cell 820 of learning cells may be added to the top. In this case, the learning cells in progress may maintain the existing order.

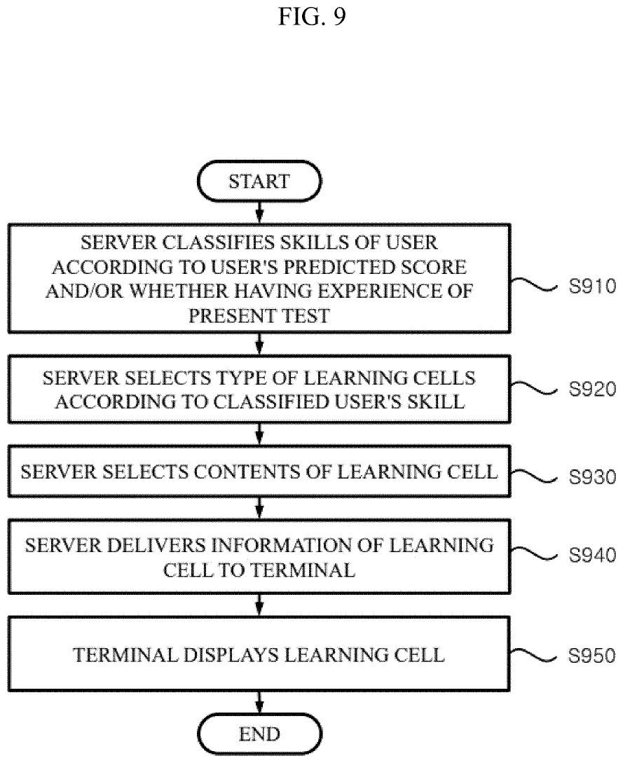

FIG. 9 is a diagram illustrating a learning delivery method of a server according to the present specification.

A server classifies skills of users according to user's predicted scores or the present test experience (S910). For example, the skills of users may be classified into three levels including basic, intermediate, and advanced (e.g., on TOEIC, a score of 500 or lower is a basic user, and a score higher than 750 is an advanced user).

The server selects types of the learning cells in accordance with classified user's skills (S920). For example, The types of recommended learning cells may be lectures, vocabularies, and questions. Even for users with the same skill, the selected types of learning cells may be different from each other depending on whether the user has the test experience. For example, for a user having no test experience, a learning cell having more types of questions than those of a user having test experience may be useful. Such an operation of selecting the type of learning cells may be performed through the AI model of the server, or may be selected on the basis of a preset probability value. More specifically, in the server, a probability value about an efficient learning method may be set in accordance with skills of users, and the types of learning cells corresponding thereto may be selected.

The server selects contents of a learning cell (S930). For example, the server may use the above-described KT model to select contents included in the learning cell. The server may select contents having a tag related to an insufficient skill in accordance with the tag related to the insufficient skill (e.g., gerund, to infinitive, or subjunctive).

The server delivers the information of the learning cell to the terminal (S940). The terminal may receive the information of the learning cell including the type and contents of the learning cell from the server, and may display the information to the user. For example, the ‘AI pick’ learning cell may be selected in the server in the same or similar method as the above-described method using creation of the AI message block (AI pick) 710 as a trigger, and may be delivered to the terminal.

The terminal displays the learning cell (S950)

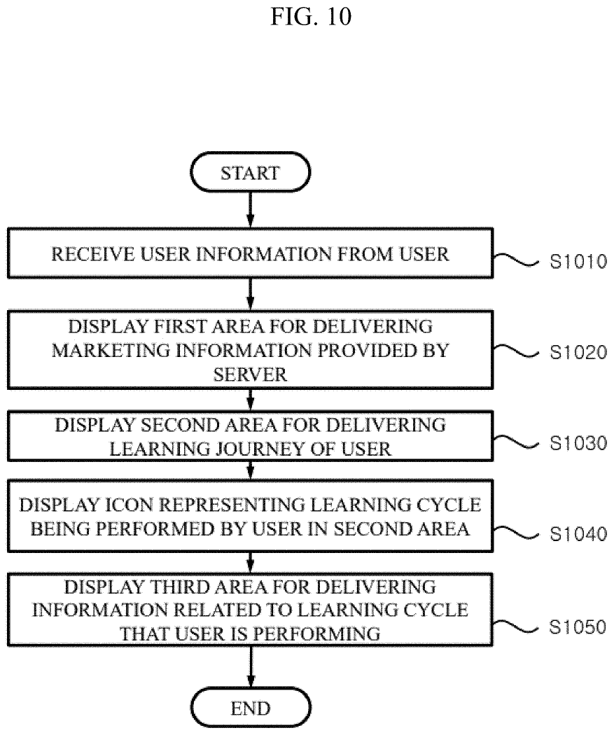

FIG. 10 is a diagram illustrating an embodiment of a terminal according to the present specification.

Referring to FIG. 10, the terminal may be connected to a network and/or the server to transmit and receive data. The operation illustrated in FIG. 10 may be performed together with or separately from the operation illustrated in FIG. 9.

The terminal receives user information from the user (S1010). For example, the terminal may receive log-in information from the user through an installed application program. The terminal may acquire user information corresponding to an ID of the user.

The terminal displays a first area for delivering marketing information provided by the server (S1020). For example, the first area may be TopBanner. The terminal may receive user-specific marketing information from the server in accordance with the user information, and display the marketing information in the first area.

The terminal displays a second area for delivering learning journey of the user to the user (S1030). For example, the second area may be Journey. The terminal may display learning journey corresponding to the user information in the second area. More specifically, the second area may include a first icon representing a score predicted through the first test, one or more second icons representing a score predicted for each learning cycle, and a third icon representing a target score of the user. Through this, the user may efficiently check the present, past, and target score.

The terminal displays an icon representing a learning cycle being performed by the user in the second area (S1040).

The terminal displays a third area for delivering information related to the learning cycle being performed by the user (S1050). For example, the third area may be a lower background area. The terminal may display information related to a learning cycle currently being performed by the user in the third area in accordance with the user information. More specifically, in the third area, the terminal may display a first frame for presenting information of the learning cycle being performed by the user, a second frame for presenting information related to learning of the learning cycle being performed by the user, and a third frame for presenting a learning card related to the learning. For example, the first frame may include a notification page, the second frame may include an AI message block, and the third frame may include a learning cell.

The second frame may include one or more AI message blocks, and such a block may be displayed on the basis of policy set in the terminal.

The third frame may include one or more learning cells, the learning cell may include 1) a type, 2) a title, 3) a tag, and 4) an icon of the learning cell, and the type may include lectures, vocabularies, and questions. In addition, the third frame may include a completion area for representing completed learning cells, and the completed learning cells may be sorted in the order of most recently completed learning cells and displayed in the completion area.

In addition, the terminal may receive a tap input for the one or more second icons, and may change a color of the second icon corresponding to the tap and display the second icon to indicate that the learning cycle of the second icon has been selected. Thereafter, the terminal may display information corresponding to the color-changed second icon in the third area.

Through this, the user may perform learning up to the target score more efficiently through the user interface of the terminal. In addition, the server may provide efficient learning to the user whenever a specific event occurs during the learning journey of the user by using the AI model.

The above-described present specification may be implemented as a computer-readable code on a program-recorded medium. The computer-readable medium includes all kinds of recording devices which store data readable by a computer system. Examples of the computer-readable medium are an HDD (Hard Disk Drive), an SSD (Solid State Disk), an SDD (Silicon Disk Drive), a ROM, a RAM, a CD-ROM, a magnetic tape, a floppy disk, an optical data storage device, and the like, and also include that implemented in a form of carrier wave (e.g., transmission through internet). Accordingly, the above detailed description should not be construed as restrictive in all respects and should be considered as exemplary. The scope of the present specification should be determined by a reasonable interpretation of the appended claims, and all modifications within the equivalent scope of the present specification are included in the scope of the present specification.

In addition, although the above description has been focused on services and embodiments, this is merely an example and does not limit the present specification, and those of ordinary skill in the art can know that various modifications and application not exemplified in the above description are possible in the scope not depart from the essential characteristics of the present service and embodiments. For example, each component specifically represented in the embodiments may be modified and implemented. In addition, differences related to such modifications and applications should be construed as being included in the scope of the present specification defined in the appended claims.

According to the embodiment of the present specification, it is possible to implement a user interface which recommends an appropriate learning journey in accordance with user's skills through an artificial intelligence model.

In addition, according to the embodiment of the present specification, it is possible to implement a user interface through which users can more efficiently determine their skills, select appropriate learning, and study, in order to improve user's skills.

The effects obtainable in the present specification are not limited to the above-mentioned effects, and other effects not mentioned will be clearly understood by those of ordinary skill in the art to which the present specification belongs from the description below.

What is claimed is:

1. A method of providing learning to a user by a terminal, comprising:
a step of receiving user information from the user;
a step of displaying a first area for delivering information provided by a server to the user on the basis of the user information;
a step of determining 1) the number and 2) a type of one or more learning cycles on the basis of a skill of the user predicted in the server and creating the learning cycles, wherein the type of the learning cycles include 1) basic vocabulary contents, 2) basic lecture contents, and 3) practical question contents;
a step of displaying a second area for delivering a learning journey of the user to the user, wherein the second area includes a first icon representing a score predicted through a first test, one or more second icons representing a score predicted for each learning cycle, and a third icon representing a target score of the user;
a step of displaying an icon representing a learning cycle being performed by the user in the second area;
a step of displaying a third area for delivering information related to the learning cycle being performed by the user;
a step of receiving a tap for the one or more icons from the user;
a step of changing and displaying a color of the second icon corresponding to the tap; and
a step of displaying information corresponding to the color-changed second icon in the third area,
wherein the step of displaying the third area includes
a step of displaying a first frame for presenting information of the learning cycle being performed by the user;
a step of displaying a second frame for presenting information related to learning of the learning cycle being performed by the user; and
a step of displaying a third frame for presenting a learning card related to the learning,
wherein the second frame includes one or more blocks, the block is displayed on the basis of policy set in the terminal, the policy includes 1) a creation time, 2) a status, and 3) a type of the block, the third frame includes one or more learning cells, the creation time includes 1) a creation time of the learning cycle and 2) a completion time of the learning cell which is not the last, the status includes 1) creation, 2) consumption, and 3) expiration, and the type includes 1) learning recommended by the server, 2) information, 3) increase of a predicted score, and 4) decrease of a predicted score.

2. The method according to claim 1, wherein the learning cell includes 1) a type, 2) a title, 3) a tag, and 4) an icon of the learning cell, and the type includes a lecture, a vocabulary, and a question.

3. The method according to claim 2, wherein the third frame includes a completion area for representing completed learning cells, and the completed learning cells are sorted in the order of the most recently completed learning cells.

4. The method according to claim 2, further comprising:
a step of delivering 1) a predicted score of a current cycle of the user and 2) information about whether the user has experience of the present test to the server;
a step of receiving 1) a type and 2) content information, of the selected learning cell on the basis of the 1) the predicted score of the current cycle of the user and 2) the information about whether the user has experience of the present test from the server; and
a step of displaying the selected learning cell in the third frame on the basis of 1) the type and 2) the content information of the selected learning cell.

5. The method according to claim 4, wherein the type of the selected learning cell is selected on the basis of a probability value preset in the server.

6. The method according to claim 4, wherein the contents of the selected learning cell are selected through a knowledge tracing (KT) model of the server.

7. A terminal which provides learning to a user, comprising:
a communication module;
a memory;
a display unit; and
a processor,
wherein the processor
receives user information from the user through the communication module;
displays a first area for delivering marketing information provided by a server to the user on the display unit on the basis of the user information;
determines 1) the number and 2) a type of one or more learning cycles on the basis of a skill of the user predicted in the server and creates the learning cycles, wherein the type of the learning cycles include 1) basic vocabulary contents, 2) basic lecture contents, and 3) practical question contents;
displays a second area for delivering a learning journey of the user to the user, wherein the second area includes a first icon representing a score predicted through a first test, one or more second icons representing a score predicted for each learning cycle, and a third icon representing a target score of the user;
displays an icon representing a learning cycle being performed by the user in the second area;
displays a third area for delivering information related to the learning cycle being performed by the user;
receives a tap for the one or more icons from the user;
changes and displays a color of the second icon corresponding to the tap;
displays information corresponding to the color-changed second icon in the third area;
displays a first frame for presenting information of the learning cycle being performed by the user, a second frame for presenting information related to learning of the learning cycle being performed by the user in order to display the information in the third area, and a third frame for representing a learning card related to the learning,
wherein the second frame includes one or more blocks, the block is displayed on the basis of policy set in the terminal, the policy includes 1) a creation time, 2) a status, and 3) a type of the block, the third frame includes one or more learning cells, the creation time includes 1) a creation time of the learning cycle and 2) a completion time of the learning cell which is not the last, the status includes 1) creation, 2) consumption, and 3) expiration, and the type includes 1) learning recommended by the server, 2) information, 3) increase of a predicted score, and 4) decrease of a predicted score.

8. The method according to claim 1, wherein the types have priority values for sorting and displaying in the order of 1) the learning recommended by the server, 2) the information, 3) the increase of the predicted score, and 4) the decrease of the predicted score.

9. The terminal according to claim 7, wherein the types have priority values for sorting and displaying in the order of 1) the learning recommended by the server, 2) the information, 3) the increase of the predicted score, and 4) the decrease of the predicted score.
